(19) United States
(12) Patent Application Publication
(10) Pub. No.: US 2013/0094600 A1
(43) Pub. Date: Apr. 18, 2013

(54) METHOD OF MANAGING TRANSFERS OF DATA BY AN INTERFACE OF BLUETOOTH TYPE

(71) Applicants: Michel Beziat, Paris (FR); Jean-Daniel Aussel, St Remy Les Chevreuses (FR)

(72) Inventors: Michel Beziat, Paris (FR); Jean-Daniel Aussel, St Remy Les Chevreuses (FR)

(73) Assignee: GEMALTO SA, Meudon (FR)

(21) Appl. No.: 13/806,778

(22) PCT Filed: Jun. 22, 2011
(86) PCT No.: PCT/EP2011/060452

§ 371 Date: Dec. 23, 2012

(30) Foreign Application Priority Data
Jun. 23, 2010 (EP) 10305672.7

(51) Int. Cl. H04B 7/26

(52) U.S. Cl. CPC H04B 7/26
USPC 375/259

(57) ABSTRACT

The embodiments of this invention describe a method for managing the transfer of data between a peripheral comprising a Bluetooth type interface and a computer device comprising a Bluetooth type interface configured to manage Bluetooth profiles allowing the transfer of audio type data characterised in that the exchange of digital non-audio type data between the peripheral and the computer device is achieved by encoding the digital data in audio format and by transmitting those digital data by means of the audio channel of the Bluetooth interface.

This invention relates to the area of Bluetooth® type telecommunications, particularly the management of data transfers between Bluetooth® type interfaces depending on the Bluetooth® profiles associated with those interfaces.

Bluetooth® is a standard applicable to short-range radio communication in the 2,402-2,480 GHz frequency band divided into 79 channels that allows communication between a host interface and a device interface.

There is a multitude of Bluetooth® profiles, for functional specifications designed for particular uses, such as for instance exchanging files, audio or video material.

Thus, depending on its profiles, a device will allow different possibilities of exchange through its Bluetooth® interface. These profiles simplify the search, connection and security procedures between Bluetooth® interfaces and improve interoperability, but lead to restrictions when the manufacturers limit the number of such profiles in devices. Thus, mobile telephones for example often comprise a Bluetooth® profile that allows audio exchange (to communicate by means of a headset or speakers, for example), but do not necessarily have profiles that make it possible to exchange other data with other devices, such as for example a smart card reader.

There is therefore a need to offer a communication method using a Bluetooth® interface between a first device and a second device allowing the transmission of data of a type that is not managed by the Bluetooth® profile of at least one of the two devices.

Thus, this invention relates to a method for managing the transfer of data between a peripheral comprising a Bluetooth type interface and a computer device comprising a Bluetooth type interface configured to manage Bluetooth profiles allowing the transfer of audio type data characterised in that the exchange of digital non-audio type data between the peripheral and the computer device is achieved by encoding the digital data in audio format and by transmitting those digital data by means of the audio channel of the Bluetooth interface.

In another aspect of the invention, the signal bits of audio type data are transmitted on at least one first frequency band and the signal bits of non-audio type data are transmitted on at least a second frequency band.

In an additional aspect of this invention, the signals transmitted on at least a first frequency band are transmitted with a first amplitude and the signals transmitted on at least a second frequency band are transmitted with a second amplitude.

In another aspect of this invention, the Bluetooth profiles allowing audio type transfers comprise:
the hands free (HFP) profile,
the headset (HSP) profile,
the advanced audio distribution (A2DP) profile.

In one embodiment of this invention, the peripheral is a smart card reader.

This invention also relates to a computer device comprising a Bluetooth type interface configured to manage Bluetooth profiles allowing the transfer of audio type data wherein the said computer device comprises means for encoding and decoding non-audio type data in an audio format in order to allow the transmission of the said data of the non-audio type on an audio channel.

This invention also relates to a peripheral comprising a Bluetooth type interface configured to manage Bluetooth profiles that allow the transfer of data of the audio and non-audio type wherein the said peripheral comprises means for encoding and decoding non-audio type data on an audio channel so as to allow the exchange of non-audio data with a computer device having a Bluetooth type interface configured to manage Bluetooth profiles allowing the transfer of audio type data only.

In another aspect of this invention, the peripheral device comprises first encoding and decoding means that allow the exchange of audio type data on an audio channel according to a first type of encoding, and second encoding and decoding means that allow the exchange of non-audio type data on the said audio channel according to a second type of encoding.

In a conventional aspect of this invention, the peripheral comprises processing means that allow the transmission of data between a first computer device comprising a Bluetooth type interface configured to manage Bluetooth profiles allowing the transfer of audio and non-audio type data and a second computer device comprising a Bluetooth type interface configured to manage Bluetooth profiles allowing the transfer of audio type data only, wherein the data received from the first computer device on a non-audio channel are encoded in audio format for transmission on an audio channel to the said second computer device on the one hand and the data of the non-audio type encoded in the audio format received from the said second computer device on an audio channel are encoded in non-audio format for transmission on a non-audio channel to the said first computer device on the other.

This invention also relates to a combined device comprising processing means that allow the transmission of data between a first computer device or peripheral comprising a Bluetooth type interface configured to manage Bluetooth profiles allowing the transfer of audio and non-audio type data and a second computer device comprising a Bluetooth type interface configured to manage Bluetooth profiles allowing the transfer of audio type data only, wherein the data received from the first computer device on a non-audio channel (9) are encoded in audio format for transmission on an audio channel (5) to the said second computer device on the one hand and the data of the non-audio type encoded in the audio format received from the said second computer device on an audio channel (5) are encoded in non-audio format for transmission on a non-audio channel (9) to the said first computer device on the other.

Other characteristics and advantages of the invention will appear in the description below, by reference to the attached drawings, which illustrate a possible embodiment, for information and in a non-limitative manner.

In these drawings:

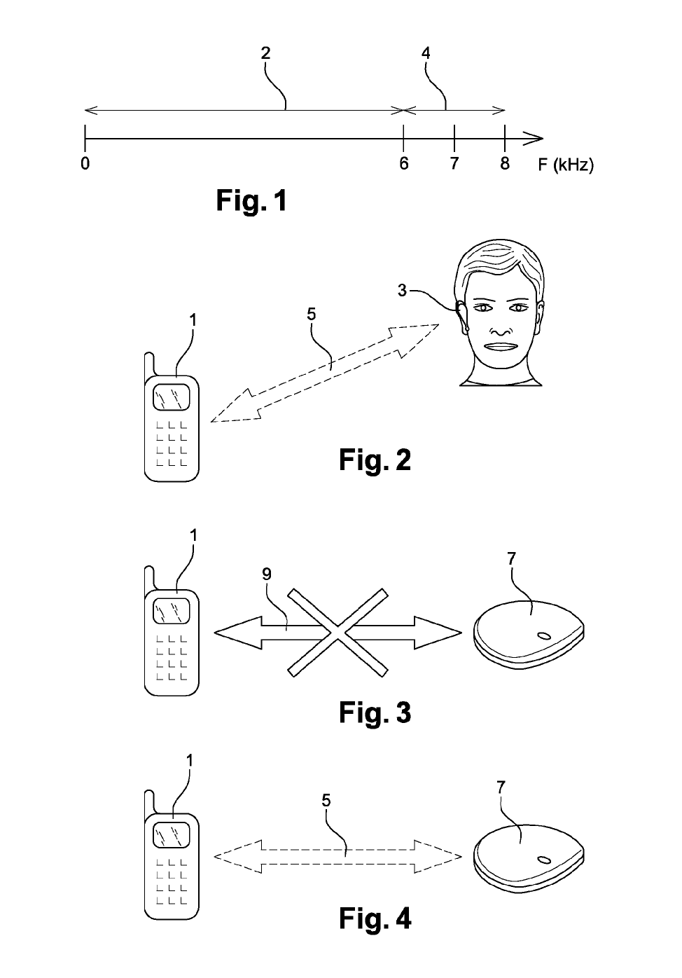

FIG. 1 represents a diagram of the distribution of the frequency bands allocated to audio and non-audio type data;

FIG. 2 represents a diagram of a Bluetooth® connection between a mobile telephone and a headset;

FIG. 3 represents a diagram of a Bluetooth® connection attempt between a mobile telephone and a smart card reader;

FIG. 4 represents a diagram of a Bluetooth® connection between a mobile telephone and a smart card reader through an audio channel;

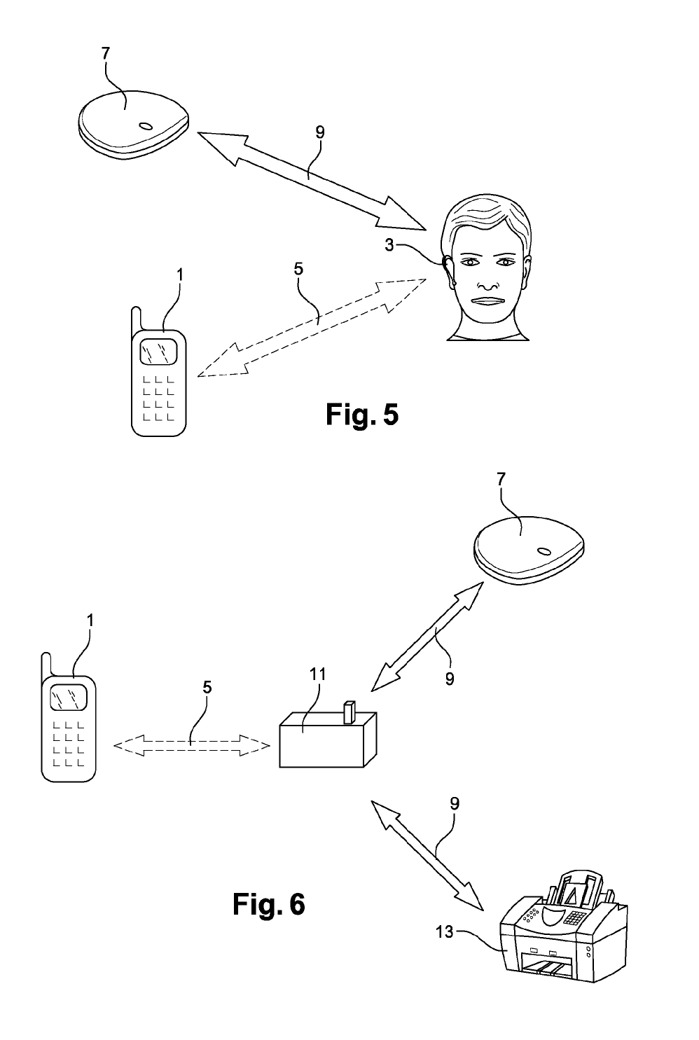

FIG. 5 represents a diagram of a double Bluetooth® connection between a mobile telephone and a headset on the one hand and between a mobile telephone and a smart card reader through a headset on the other hand;

FIG. 6 represents a diagram of use of a combined device allowing Bluetooth® connection between a mobile telephone and devices or peripherals on the other hand;

In the description below, the following are generally designated:

The term “computer device” means an electronic device comprising processing means allowing the use of communication through a Bluetooth® interface. The computer device is the host device for Bluetooth® communication.

The term “peripheral” means an electronic device comprising processing means allowing the setting up of communication through a Bluetooth® interface with a computer device. The peripheral is the device for Bluetooth® communication.

The term “combined device” means electronic equipment comprising processing means allowing the use of communication through a Bluetooth® interface with at least one computer device on the one hand and at least one peripheral on the other.

The embodiments of this invention are aimed at transmitting, on a Bluetooth® channel of the audio type, non-audio type data in order to allow a computer device with only one or more audio data management profiles to communicate non-audio type data with a device configured to receive non-audio type data (through dedicated ® profiles, Universal Serial Bus (USB), connections, serial connections, Firewire or other means of communicating with other peripheral devices).

To that end, the non-audio type data are encoded into a format of the audio type to allow transmission on an audio channel managed by a Bluetooth® profile for audio data.

Besides, in the event of the simultaneous transmission of audio and non-audio data on an audio channel, the presence of non-audio data can lead to great nuisance for the user or users. Indeed, if a computer device such as a mobile telephone has a peripheral such as a headset, transmitting non-audio data on the audio channel could lead to the emission of noise that could be unpleasant or even harmful to the ears of the user.

In order to overcome that problem, in one embodiment of this invention, non-audio type data are transmitted on different frequency bands from audio type data inside the audio channel, so as to separate the audio type data from non-audio type data when the signal is received. FIG. 1 is for example a representation of the distribution of frequency bands in the audio channel. Considering that the channel covers a range of 50 Hz to 8 kHz, the 50 Hz-6 kHz 2 band is set aside for audio type signals and the 6 kHz-8 kHz 4 band is set aside for non-audio type signals. To that end, a carrier located at 7 kHz is modulated by the non-audio type signals. Further, the amplitude of the modulate signal obtained is limited (for example to 10 or 20% of the amplitude of audio type signals) so that the noise produced by those signals of non-audio type data remains low.

In another embodiment, non-audio data are encoded by wide-spectrum modulation so that the sound produced by the transmission of such data is distributed over a set of frequencies with low levels (creating low-intensity white noise), so that the sound produced (equivalent to a slight hiss) does not disturb the users of the radio device (headset, earphones, speakers etc.).

In an alternative embodiment, the non-audio data are encoded by an audio watermarking technique that makes them almost inaudible, that is to say hardly perceptible to the user. However, it must be noted that a small noise may be tolerated so as to increase the quantity of the non-audio data that can be transmitted using the technique.

Alternatively, non-audio data are encoded so as to produce sound at frequencies that are inaudible for the user or users of the audio device.

In order to better understand the invention, different configurations of this invention will now be described from examples of embodiments.

In the case of mobile phones or smart phones, a Bluetooth interface is generally available to allow the use of an audio peripheral such as a headset. Thus, as shown in FIG. 2, the smart phone 1 can communicate with a headset 3 through the Bluetooth audio channel 5, the connection being managed by a dedicated Bluetooth profile such as for example the hands free profile (HFP) or the headset profile (HSP) or the advanced audio distribution profile (A2DP), which allow the encoding and transmission of audio data between the smart phone 1 and the headset 3.

However, if the smart phone does not have a smart card reader, as is often the case, the user of the smart phone may want to connect it to a smart card reader, which is not possible either by means of its Universal Serial Bus (USB) connector when there is one, because the smart card reader is not a host USB device.

But, as shown in FIG. 3, the smart phone cannot communicate with the smart card reader 7 through a non-audio data transfer channel 9 if the smart phone 1 does not have a Bluetooth profile managing such data, such as a the serial port profile (SPP). Thus, the absence of a suitable Bluetooth profile makes it impossible to exchange data between the smart phone 1 and the smart card reader 7.

In order to overcome that problem, the embodiments of this invention transmit non-audio type data on the audio channel 5 so that the data can be managed by the Bluetooth profile of the smart phone 1 as represented in FIG. 4. Non-audio data are thus encoded in an audio format and then transmitted by the audio channel 5 between the smart phone 1 and the smart card reader 7.

In another embodiment presented in FIG. 5, the audio channel makes it possible to transfer data of the audio and non-audio type at the same time. In this example, the audio type data are intended for the user of the headset 3 and are transmitted by the audio channel 5 whereas non-audio type data are intended for a smart card reader but also go through the headset 3 via the audio channel 5 between the smart phone 1 and the headset 3, then through a non-audio channel between the headset 3 and the smart card reader 7, the headset 3 acting as a bridge between the smart phone 1 and the smart card reader 7. In this configuration, non-audio type data transmitted by the audio channel must be encoded so as to avoid disrupting the working of the headset as described above.

In another embodiment shown in FIG. 6, a combined device 11 comprising firstly a Bluetooth® interface configured to exchange audio type data with a smart phone 1 and secondly a Bluetooth® interface configured to exchange non-audio type data with peripherals or computer devices (for example a smart card reader 7 or a printer 13) comprising Bluetooth® interfaces through a non-audio channel 9 and thanks to appropriate Bluetooth® profiles is used as the bridge between the smart phone and the other devices or peripherals (such as the headset in the previous embodiment). Thus, the combined device 11 makes it possible, as before, to exchange non-audio type data between a smart phone 1 with a Bluetooth interface configured only for exchanging audio data and computer devices or peripherals comprising Bluetooth® interfaces configured for exchanging non-audio type data.

It must be noted that in order to communicate with computer devices and peripherals, the combined device must comprise a host type Bluetooth interface and a device type interface. The value of the combined device for users of the smart phone is that it is a simple device that allows them to communicate with all standard devices or peripherals.

Thus, the embodiments of this invention allow users of computer devices with a Bluetooth profile that manages the exchange of audio data to exchange other types of data on the audio channel without modifying the hardware of their computer device, and thus increase the possibilities of the Bluetooth interface of their computer device.

1. A method for managing the transfer of data between a peripheral device comprising a Bluetooth type interface and a computer device (1) comprising a Bluetooth type interface configured to manage these Bluetooth profiles allowing the transfer of data of the audio type wherein the exchange of digital non-audio type data between the peripheral device and the computer device (1) is achieved by encoding the digital data in audio format and by transmitting those digital data by means of the audio channel (5) of the Bluetooth interface.

2. The method of managing the transfer of data according to claim 1, wherein the signal bits of audio type data are transmitted on at least one first frequency band and the signal bits of non-audio type data are transmitted on at least a second frequency band.

3. The method of managing the transfer of data according to claim 2, wherein the signals transmitted on at least a first frequency band are transmitted with a first amplitude and the signals transmitted on at least a second frequency band are transmitted with a second amplitude.

4. A The method for managing the transfer of data according to any of the foregoing claims wherein the Bluetooth profiles that allow audio type transfers comprise:
the hands free (HFP) profile,
the headset (HSP) profile,
the advanced audio distribution (A2DP) profile.

5. The method of management of the transfer of data according to any of claims 1 through 3, wherein the peripheral is a smart card reader (7).

6. A computer device comprising a Bluetooth type interface configured to manage Bluetooth profiles allowing the transfer of audio type data wherein the said computer device (1) comprises means for encoding and decoding non-audio type data in an audio format in order to allow the transmission of the said data of the non-audio type on an audio channel (5).

7. A peripheral comprising a Bluetooth type interface configured to manage Bluetooth profiles that allow the transfer of data of the audio and non-audio type wherein the said peripheral comprises means for encoding and decoding non-audio type data on an audio channel (5) so as to allow the exchange of non-audio data with a computer device having a Bluetooth type interface configured to manage Bluetooth profiles allowing the transfer of audio type data only.

8. The peripheral according to claim 7, comprising first encoding and decoding means that allow the exchange of audio type data on an audio channel (5) according to a first type of encoding, and second encoding and decoding means that allow the exchange of non-audio type data on the said audio channel (5) according to a second type of encoding.

9. The peripheral according to claim 7 or 8 comprising processing means that allow the transmission of data between a first computer device comprising a Bluetooth type interface configured to manage Bluetooth profiles allowing the transfer of audio and non-audio type data and a second computer device comprising a Bluetooth type interface configured to manage Bluetooth profiles allowing the transfer of audio type data only, wherein the data received from the first computer device on a non-audio channel (9) are encoded in audio format for transmission on an audio channel (5) to the said second computer device on the one hand and the data of the non-audio type encoded in the audio format received from the said second computer device on an audio channel (5) are encoded in non-audio format for transmission on a non-audio channel (9) to the said first computer device on the other.

10. A combined device comprising processing means that allow the transmission of data between a first computer device or peripheral comprising a Bluetooth type interface configured to manage Bluetooth profiles allowing the transfer of audio and non-audio type data and a second computer device comprising a Bluetooth type interface configured to manage Bluetooth profiles allowing the transfer of audio type data only, wherein the data received from the first computer device on a non-audio channel (9) are encoded in audio format for transmission on an audio channel (5) to the said second computer device on the one hand and the data of the non-audio type encoded in the audio format received from the said second computer device on an audio channel (5) are encoded in non-audio format for transmission on a non-audio channel (9) to the said first computer device on the other.
